(19) United States
(12) Patent Application Publication
(10) Pub. No.: US 2007/0209277 A1
(43) Pub. Date: Sep. 13, 2007

(54) Floating wetland raft

(76) Inventors: Richard J. Schuck, Jarrettsville, MD (US); Brian Schuck, Charleston, SC (US); Stuart Schuck, Mt. Pleasant, SC (US); Robert K. Hubbard, Valdosta, GA (US)

Correspondence Address: Ober, Kaler, Grimes & Shriver;Attorneys at Law, 120 East Baltimore Street, Baltimore, MD, 21202-1643, US

(21) Appl. No.: 11/709,327

(22) Filed: Feb. 21, 2007

Related U.S. Application Data
(60) Provisional application No. 60/775,075, filed on Feb. 21, 2006.

(51) Int. Cl. A01G 31/00

(52) U.S. Cl. 47/59 R

(57) ABSTRACT

A floating wetland raft comprising a floating raft body onto which is attached a biodegradable mat. The floating raft body is preferably made of closed cell polyethylene foam, and the mat may be woven of coir fiber. The mat covers the raft body and nests into an open area therein. The mat serves as a surface on which aquatic plants are grown for consuming nutrients from the water beneath. The biodegradable mat and associated plant biomass can be removed and subsequently replanted elsewhere or composted. The nutrients contained in the removed biomass represent a permanent reduction of nutrients in the water from whence they came. The floating raft body is durable and can be used repeatedly by attaching a freshly planted mat and repeating the nutrient removal process, which helps alleviate the problem of nutrient overloading in bodies of water.

### BACKGROUND OF THE INVENTION

1. Field of the Invention

The present invention relates to reducing polluting nutrients in estuarine and freshwater bodies of water, more particularly, to a floating wetland raft for growing aquatic plants that consume nutrients from the water, and then for allowing easy removal of the created vegetative nutrient-containing biomass to achieve permanent nutrient reduction.

2. Description of the Background

Many, perhaps all, bodies of water are degraded by nutrient overloading, i.e., receiving more nutrients than can be handled without negatively affecting the flora and fauna of the body of water in question. Mainly a burgeoning human population and its activities, domestic, agricultural and industrial, cause this overloading of nutrients.

The Chesapeake Bay, for example, receives the storm and wastewater runoff of 64,000 square miles of land in Maryland, Virginia, Delaware, Pennsylvania, and New York states. The State of Maryland created 17,700 storm-water retention ponds encompassing 174,000 acres to manage and reduce the nutrient and sedimentary run-off from this watershed into the Chesapeake Bay. This system has failed to control this problem adequately as the Bay continues to be degraded by nutrient overload from storm-water run-off.

The failure of the ponds to do the job may be attributable to their propensity to endlessly accumulate nutrients. While the plants and algae that flourish in the ponds consume and hold nutrients via foliage production and photosynthesis, they release nearly this entire nutrient load back into the ponds when the plants decompose at the end of the growing season or plant life cycle. Thus, the ponds serve only as temporary holding reservoirs for nutrients, most of which will eventually make their way into the estuary system.

Apparatuses for floating and growing aquatic plants in water have been designed, to address this issue of purification or nutrient reduction of water. For example, U.S. Pat. No. 5,799,440 issued to Ishikawa on Sep. 1, 1998 discloses a foam resin raft/planter onto which a plant cultivation bag, for growing wetland plants, is placed. The raft is encumbered by tethered and suspended oxygen generating containers. The roots of the plants extend through the bag and holes in the raft and out into the water. Once the plants are grown, the bag may be removed and replanted elsewhere.

U.S. Pat. No. 5,337,516 issued to Hondulus on Aug. 16, 1994 discloses an apparatus for treating wastewater including a wastewater basin and wetland plants in containers suspended in the basin such that the plants' roots treat the water. These containers are raised and lowered into the water using mechanically operated platforms.

Although the Ishikawa '440 and Hondulus '516 apparatuses both serve to purify or reduce nutrients in water, none do so as quickly and effectively as the floating wetland raft disclosed herein. The Ishikawa '440 apparatus has oxygen-generating containers suspended from the raft that would complicate its deployment and removal from the water being treated. The plant cultivation bags do not afford immediate and intimate contact of the plants' roots to the water, thus delaying and possibly lessening nutrient uptake.

The Hondulus '516 apparatus requires mechanically raising and lowering plant-filled containers thereby making the entire process very labor and time-intensive. Also, the Hondulus '516 apparatus is limited to wastewater basins and therefore not generally applicable to storm-water retention ponds or other ponds of an irregular shape.

It would be greatly advantageous to provide a floating wetland raft such as disclosed herein to help solve the nutrient consumption-release cycle currently defeating the purpose of the storm-water run off ponds. A wetland raft that allows for easy deployment and retrieval of plants from ponds will facilitate the easy removal of vegetative biomass grown on the raft and subsequent composting, sale or reuse thereof in another application. Of course, removal of the nutrients contained in the biomass permanently eliminate the same from the pond and hence from the estuary system.

### SUMMARY OF THE INVENTION

It is, therefore, an object of this invention to provide a floating wetland raft having a floating raft, a biodegradable mat, and raft tethering hardware that combine to create an easily deployable and retrievable aquatic plant growing apparatus that can be used to reduce nutrients in storm-water ponds or any other nutrient-rich body of water.

It is another object to provide a floating wetland raft having a floating raft that is reusable from year-to-year and which can be recycled at the end of its useful life.

It is still another object to provide a floating wetland raft having a biodegradable mat that retains sufficient strength after being in water for up to one year such that it can be removed, handled, and possibly replanted elsewhere without falling apart in the process.

Another object is to provide a floating wetland raft having a biodegradable mat onto which aquatic plants may grow and their associated vegetative biomass may be easily removed.

Yet another object is to provide a floating wetland raft that is fabricated of lightweight materials providing an appropriate degree of flexibility, resiliency, durability, and longevity.

Still is another object is to provide a floating wetland raft that possesses a simple and scalable design.

An additional object is to provide a floating wetland raft that may be economically manufactured and sold to provide for widespread use and disposability.

According to the present invention, the above described and other objects are accomplished by providing a floating wetland raft comprised of a closed-cell polyethylene foam floating raft onto which a fiber mat is attached for the purpose of holding and growing aquatic plants. The fiber mat is made of a biodegradable material of sufficient thickness and strength to contain plants for the duration of their growing season or life cycle (up to one year). The fiber mat is attached to the raft in such a way that it and its associated vegetative biomass can be easily removed. The entire apparatus is lightweight and easily handled by one or two people.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective view of the floating raft body 2 and attached fiber mat 3.

FIG. 2 is a cross-sectional side view of the floating raft body 2 and attached fiber mat 3 as in FIG. 1.

FIG. 3 is a top view of the floating raft body 2 and attached fiber mat 3 as in FIGS. 1 and 2.

FIG. 4 is an exploded cross-sectional side view of the raft body 2 and mat assembly 3 as in FIGS. 1-3.

FIG. 5 is a cross-sectional side view showing the placement of wetland plants 9 into a fiber mat 3 as in FIGS. 1-4.

FIG. 6 is a cross-sectional side view of an alternate embodiment of a fiber mat 8.

### DETAILED DESCRIPTION OF THE PREFERRED EMBODIMENTS

The present invention is a easily deployable floating wetland raft 1 for reducing nutrients in storm-water retention ponds or any body of water that collects nutrient-laden water.

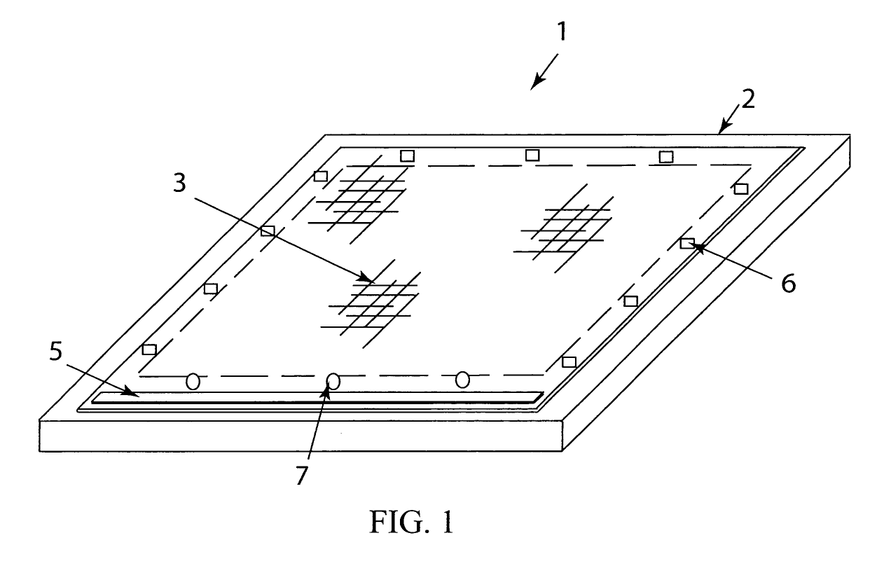

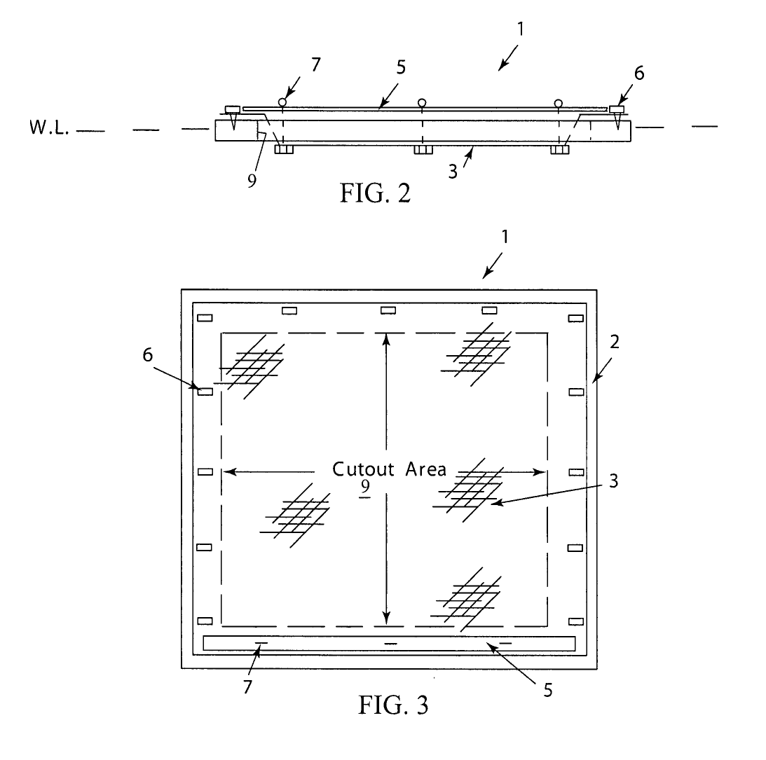

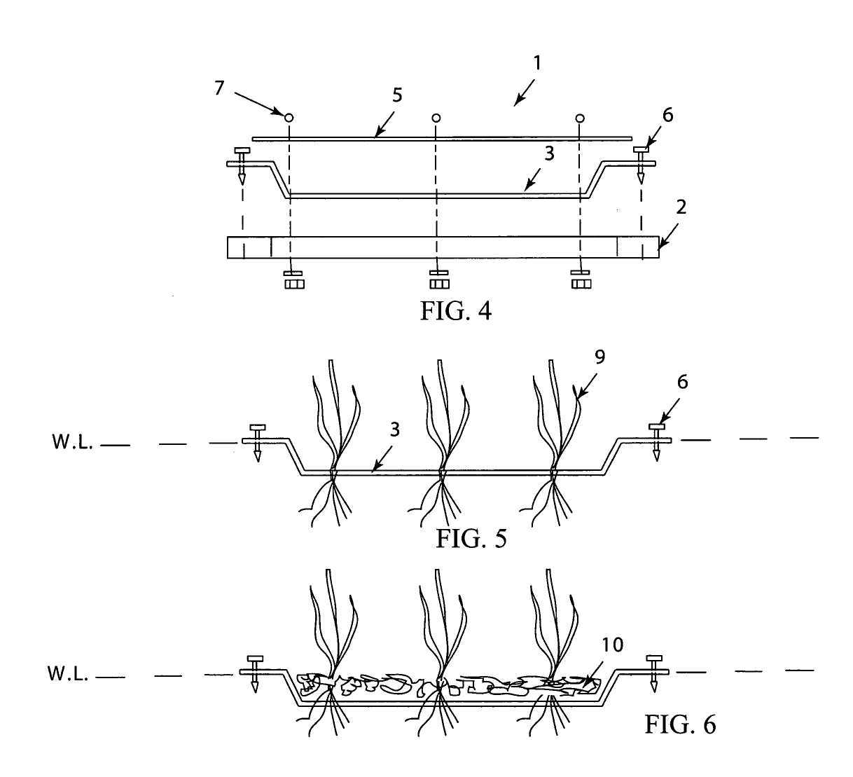

FIGS. 1-4 are perspective, cross-sectional side, top, and exploded cross-sectional side views, respectively of the floating wetland raft 1 according to a preferred embodiment of the present invention. The floating wetland raft 1 comprises a floating raft body 2 onto which is attached a removable and biodegradable fiber mat 3. The fiber mat 3 serves as a surface on which wetland plants 9 are grown for consuming nutrients from the water beneath (growth of wetland plants 9 is discussed in reference to FIG. 5).

A single-layer fiber mat 3 covers the top of the floating raft body 2, and the mat 3 is of sufficient area and thickness to nest in the open area of the raft body 2. This assures that the nested portion of the mat 3 will be partially submerged in the water and stay wet, which is important for growing wetland plants 9. An aluminum bar 5 is attached to the leading edge of the raft body 2 via stainless steel eyebolts, nuts and fender washer assemblies 7. The illustrated aluminum bar 5 is 1¼″ wide by ⅛″ thick, and is of sufficient length to reach from one end of the raft body 2 to the other end. The bar 5 has at least three ⅜″ diameter holes through which stainless steel bolts 7 are inserted (here approximately ¼″ diameter bolts 7). The stainless steel bolts 7 are of sufficient length to reach through the thickness of the raft body 2. Additionally, the steel bolts 7 are of sufficient protruding length to allow stainless steel washers 7 and nuts 7 to be securely attached. The strong rust-proof hardware 5, 7, used to secure the leading edge of the raft body 2 to the fiber mat 3, serves as a fixture onto which an anchor or tethering line can be attached. The hardware 5, 7 also protects the floating wetland raft 1 from tearing while being tethered, towed or anchored.

Barbed biodegradable stakes/fasteners 6 further help to attach and secure the floating raft body 2 to the fiber mat 3. Stakes 6 are pressed through the fiber mat 3 into the raft body 2 along all sides. For example, 4″ Green Stakes which are 100% biodegradable, may be used as the stakes/fasteners 6 in the present invention. The mat 3 is attached to the raft body 2 in such a way that the mat 3 and its associated vegetative biomass are easily removable (growth of wetland plants 9 and biomass is discussed in reference to FIG. 5).

Both the floating raft body 2 and fiber mat 3 are generally square-shaped. The floating raft body 2 is cut from a blank of closed-cell black polyethylene foam that is both UV and water-resistant. The floating raft body 2 is durable and can be used repeatedly. The fiber mat 3 is made of a biodegradable material of sufficient thickness and strength to contain wetland plants 9 for the duration of their growing season or life cycle (up to one year). Particularly, the mat 3 is constructed of tightly woven coconut (coir) fiber twine ⅛″ inches in diameter, in which the twine is woven in opposite horizontal and vertical directions to form a mat-like structure. Coconut fiber when woven in this way is very strong and durable enough to be used repeatedly. The fiber mat 3 retains sufficient strength after being in water for up to one year such that it can be removed, handled, and possibly replanted elsewhere without falling apart in the process. Also, the biodegradable nature of the mat 3 allows it and its associated vegetative biomass to be used as compost.

FIG. 5 is a cross-sectional side view showing the placement of wetland plants 9 into a fiber mat 3 as in FIGS. 1-4. Wetland plants 9 can be planted in the floating wetland raft 1, particularly in the nested portion of the mat 3. The roots of the wetland plants 9 extend down through the mat 3 into the water below. Wetland plants 9 consume nutrients via the roots of the plants 9 suspended in the water. The plants 9, through the process of photosynthesis, take up nutrients from the water and convert them to vegetative biomass. This biomass can be shorn from the fiber mat 3, or the fiber mat 3 and associated plant biomass 9 can be lifted en masse off the raft body 2 after detaching the tethering hardware 5 and 7 and removing the barbed stakes 6. When this plant biomass 9 is removed, the nutrients contained therein are also removed. The nutrients contained in the removed biomass 9 represent a permanent reduction of nutrients in the water from whence they came. The nutrient removal process may be repeated by attaching a freshly planted fiber mat 3 to the durable floating raft body 2. Through the nutrient removal process, the floating wetland raft I helps alleviate the problem of nutrient overloading in bodies of water.

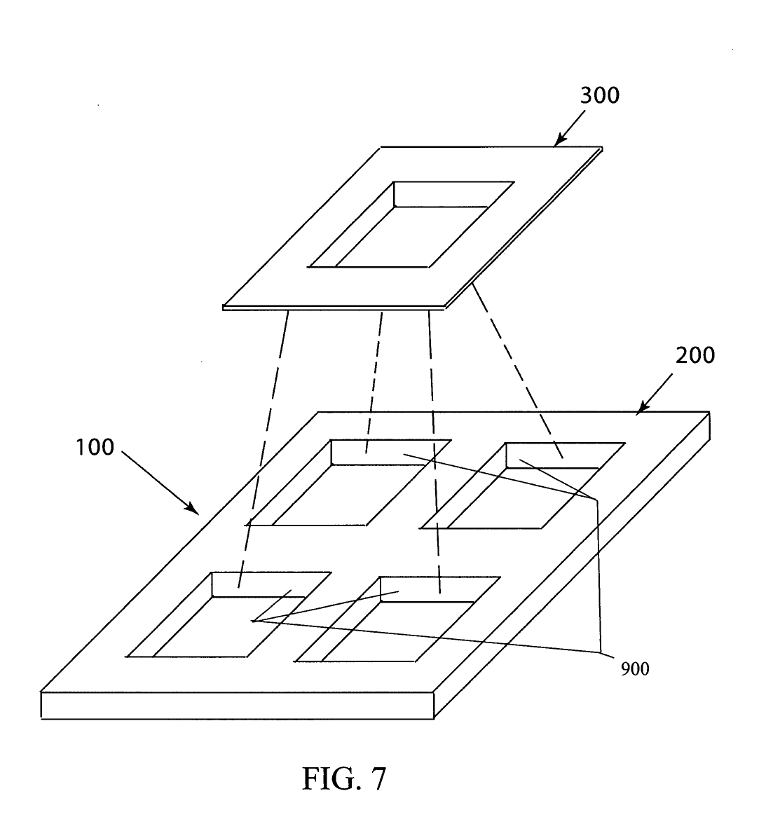

FIG. 6 is a cross-sectional side view of an alternate embodiment of a fiber mat 8, which is folded or double-layered to form top and bottom layers defining an envelope containing potting soil 10 sandwiched between the top and bottom layer of the mat 8. An envelope of potting soil 10 may be necessary to grow certain wetland plants 9 that require potting soil 10 rather than just water alone to grow roots.

Additionally the floating wetland raft 1 is lightweight and easily handled by one or two people. Also, it possesses a simple scalable design and provides the appropriate degree of flexibility, resiliency, durability, and longevity. The components are simple to assemble, inexpensive to manufacture and sell, thereby providing for widespread use and disposability.

Having now set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed is:

1. A floating wetland raft, comprising:
a raft body formed as a frame with an open area bounded by a buoyant perimeter;
a biodegradable mat removably attached to one side of said raft body and protruding toward another side through said open area for growing aquatic plants; and
a clamp for securing said biodegradable mat atop said raft body along one side, and for attachment of a tether thereto for positioning the raft in a body of water being treated.

2. The floating wetland raft according to claim 1, wherein said mat is nested in said open area of said raft body.

3. The floating wetland raft according to claim 1, wherein said mat comprises closely woven, biodegradable, coconut fiber twine.

4. The floating wetland raft according to claim 1, wherein said clamp is rust proof.

5. The floating wetland raft according to claim, further comprising biodegradable stakes for attaching said mat to said raft body.

6. The floating raft according to claim 1, wherein said raft body comprises closed cell polyethylene foam.

7. The floating raft according to claim 6, wherein said foam is black to resist ultraviolet damage.

8. An alternate floating wetland raft, comprising a:
a raft body constructed of closed cell black polyethylene foam, and having a plurality of open areas within its perimeter;
a corresponding plurality of preformed coir fiber-natural latex inserts that snugly fit into the cutouts in said raft body for growing aquatic plants, wherein said inserts do not require fasteners to pin them to the raft body;
and fastening means for securing said biodegradable mat atop said raft body, and for attachment of a tether to said fastening means for positioning the raft in a body of water being treated.

9. The floating wetland raft according to claim 8, wherein multiple cutouts are included within a perimeter of said raft body.

10. The floating wetland raft according to claim 8, wherein an equal number of preformed coir inserts snugly fit into said cutouts.

11. The floating wetland raft according to claim 8, wherein said coir inserts comprise biodegradable coir (coconut) fiber and natural latex.

12. The floating wetland raft according to claim 8, wherein said tethering hardware is rust proof.

13. The floating raft according to claim 8, wherein said raft body comprises closed cell polyethylene foam.

14. The floating raft according to claim 8, wherein said foam is black to resist ultraviolet damage.
